(19) United States
(12) Patent Application Publication
(10) Pub. No.: US 2014/0077899 A1
(43) Pub. Date: Mar. 20, 2014

(54) BAND-PASS FILTER

(71) Applicant: Chih-Wen Huang, Taipei (TW)

(72) Inventor: Chih-Wen Huang, Taipei (TW)

(21) Appl. No.: 13/721,043

(22) Filed: Dec. 20, 2012

(30) Foreign Application Priority Data
Sep. 18, 2012 (TW) 101134168

(51) Int. Cl. H01P 1/203

(52) U.S. Cl. CPC H01P 1/205
USPC 333/204

(57) ABSTRACT

A band-pass filter including a double-sided circuit board, an input terminal, an output terminal and a plurality of resonance units are provided. The double-sided circuit board includes a first conductor layer and a second conductor layer. The first conductor layer includes a grounded metal layer. The grounded metal layer includes one or more vias to connect to a grounded layer of the second conductor layer. The input terminal is disposed in the first conductor layer to receive a signal. The output terminal is disposed in the first conductor layer to output the filtered signal. The resonance units are disposed in the first and second conductor layers respectively, wherein the number of the resonance units is N, and N is a positive integer greater than or equal to 3.

### CROSS-REFERENCE TO RELATED APPLICATION

This application claims the priority benefit of Taiwan application serial no. 101134168, filed on Sep. 18, 2012. The entirety of the above-mentioned patent application is hereby incorporated by reference herein and made a part of this specification.

### BACKGROUND

1. Technical Field

The invention relates generally to a technique of preventing electromagnetic radiation, and more particularly to a band-pass filter technique.

2. Related Art

Recently, as mobile communication techniques have advanced rapidly and the microwave communication industry has also grown in relative terms, the importance of high frequency circuit design cannot be ignored. With regards to wireless radio frequency (RF) terminal circuits and communication systems, the band-pass filter is one of the essential high frequency components in a mobile communication product. FIG. 1 is a schematic view of a conventional parallel coupled microstrip band-pass filter. With reference to FIG. 1, a band-pass filter 10 is disposed on a substrate 12, and the band-pass filter 10 includes an input terminal 110, an output terminal 120, and a plurality of resonators 130.

The band-pass filter 10 depicted in FIG. 1 adopts a common band-pass filter design with a simple application principle and a low cost, although the circuit area needed is comparatively large. Accordingly, a modified design bends the resonators 130 between the input terminal 110 and the output terminal 120 into a hairpin shape. FIG. 2 is a schematic view of a conventional hairpin band-pass filter. With reference to FIG. 2, a band-pass filter 20 is disposed on a substrate 22, and the band-pass filter 20 includes an input terminal 210, an output terminal 220, and a plurality of resonators 230. The band-pass filter 20 not only maintains the functions of the original band-pass filter 10, but the area taken on the circuit board can be effectively reduced.

The parallel coupled microstrip band-pass filter and the hairpin band-pass filter have a plurality of mutually parallel resonators on the input and output terminals, and due to the mutual coupling of the resonators, the entire filter achieves the band-pass filtering function. However, a common problem with the two aforementioned types of band-pass filters is the harmonic noise issue. FIG. 3 is a frequency response diagram of a hairpin band-pass filter obtained from an electromagnetic simulation. With reference to FIG. 3, since the multiple frequencies of the harmonics (i.e., 2f₀, 3f₀, 4f₀, 5f₀, 6f₀) do not exist ideally, in order to remove the interference from the harmonic noise, a low-pass filter is conventionally connected in series so as to remove the high frequency noise generated by the band-pass filter. Accordingly, the design and manufacturing costs are increased drastically.

### SUMMARY

Accordingly, the invention provides a band-pass filter capable of maintaining a preferable band-pass filtering function without altering the size of the original circuit, and capable of effectively preventing the issue of high frequency harmonic noise.

The invention provides a band-pass filter, including a double-sided circuit board, an input terminal, an output terminal, and a plurality of resonance units. The double-sided circuit board has a first conductor layer and a second conductor layer, in which the first conductor layer includes a grounded metal layer having one or more vias to connect to a grounded layer of the second conductor layer. The input terminal is disposed in the first conductor layer to receive a signal. The output terminal is disposed in the first conductor layer to output the filtered signal. The resonance units are disposed in the first and second conductor layers respectively, in which the number of the resonance units is N, where N is a positive integer greater than or equal to 3.

According to an embodiment of the invention, a first resonance unit of the plurality of resonance units is directly connected to the input terminal, a second resonance unit of the plurality of resonance units is directly connected to the output terminal, and the first resonance unit and the second resonance unit are disposed in the first conductor layer.

According to an embodiment of the invention, each of the resonance units not directly connected to the input terminal or the output terminal are disposed interlaced in the first conductor layer and the second conductor layer.

According to an embodiment of the invention, the resonance units include a first conductive line, a second conductive line, and a connecting line, in which the first conductive line is parallel with the second conductive line, and the connecting line is connected to the first conductive line and the second conductive line perpendicularly.

According to an embodiment of the invention, each of the resonance units disposed in the first conductor layer and not directly connected to the input terminal or the output terminal further includes a via disposed on the connecting line to connect to the grounded layer of the second conductor layer.

According to an embodiment of the invention, the via disposed in each of the resonance units of the first conductor layer is further disposed in a center location of the connecting line.

According to an embodiment of the invention, each of the resonance units disposed in the second conductor layer further includes a via disposed in the connecting line to connect to the grounded metal layer of the first conductor layer.

According to an embodiment of the invention, the via disposed in each of the resonance units of the second conductor layer is further disposed in a center location of the connecting line.

In summary, in the band-pass filter provided in embodiments of the invention, for the resonance units between the input and output terminals, coupling structures are formed between different conductor layers of the double-sided circuit board. By the design of the via positions, the band-pass filter maintains the microstrip structure and the band-pass filtering function, while effectively preventing the issue of high frequency harmonic noise.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional parallel coupled microstrip band-pass filter.

FIG. 2 is a schematic view of a conventional hairpin band-pass filter.

FIG. 3 is a frequency response diagram of a hairpin band-pass filter obtained from an electromagnetic simulation.

FIG. 4 is a schematic perspective view of a band-pass filter according to an embodiment of the invention.

FIG. 5A is a schematic view of a first conductor layer 421 according to an embodiment of the invention.

FIG. 5B is a schematic view of a second conductor layer 422 according to an embodiment of the invention.

FIG. 6 is a schematic cross-sectional view along a A-A′ line shown in FIG. 4.

FIG. 7 is a schematic perspective view of a band-pass filter according to another embodiment of the invention.

FIG. 8A is a schematic view of a first conductor layer 721 according to another embodiment of the invention.

FIG. 8B is a schematic view of a second conductor layer 722 according to another embodiment of the invention.

FIG. 9 is a schematic cross-sectional view along a B-B′ line shown in FIG. 7.

FIG. 10 is a comparative frequency response diagram of the band-pass filter 20 of FIG. 2 and the band-pass filter 40 of FIG. 4 obtained from an electromagnetic simulation.

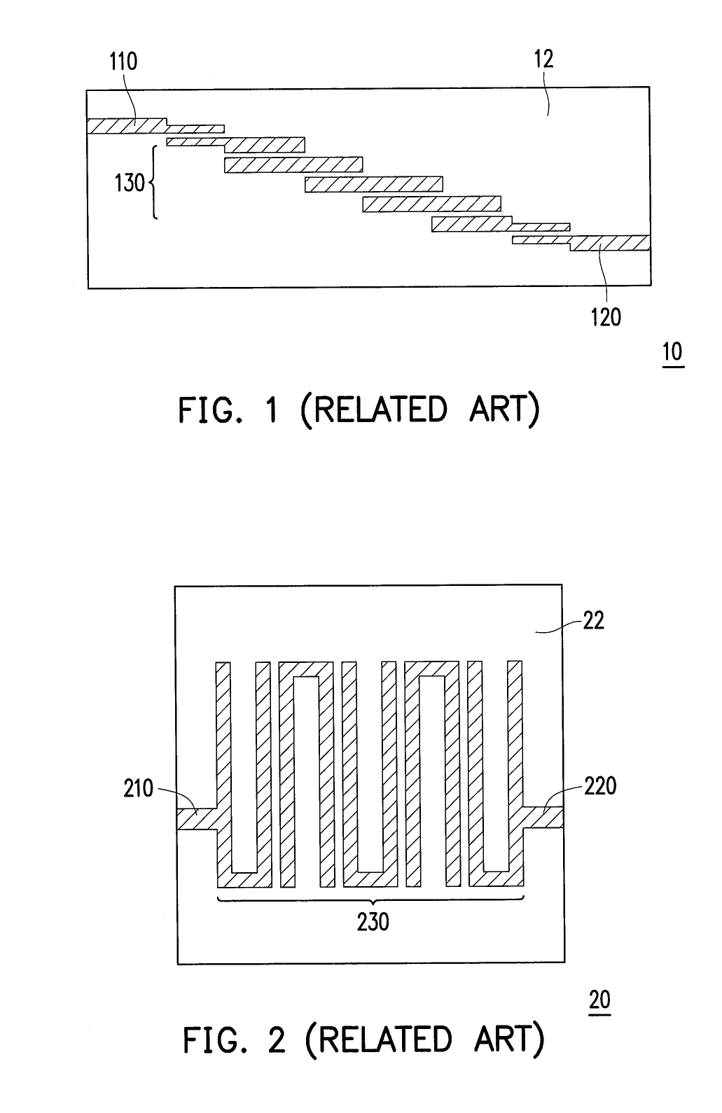

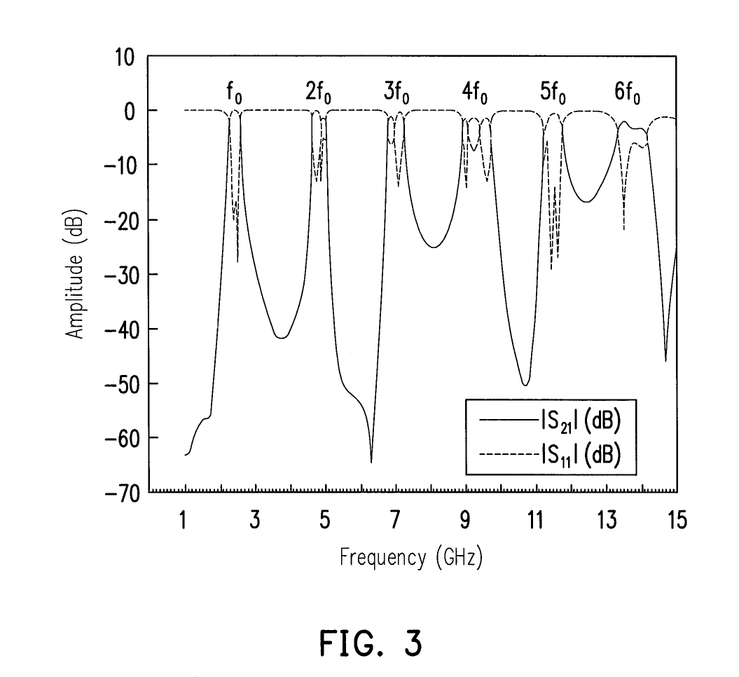

### DESCRIPTION OF EMBODIMENTS

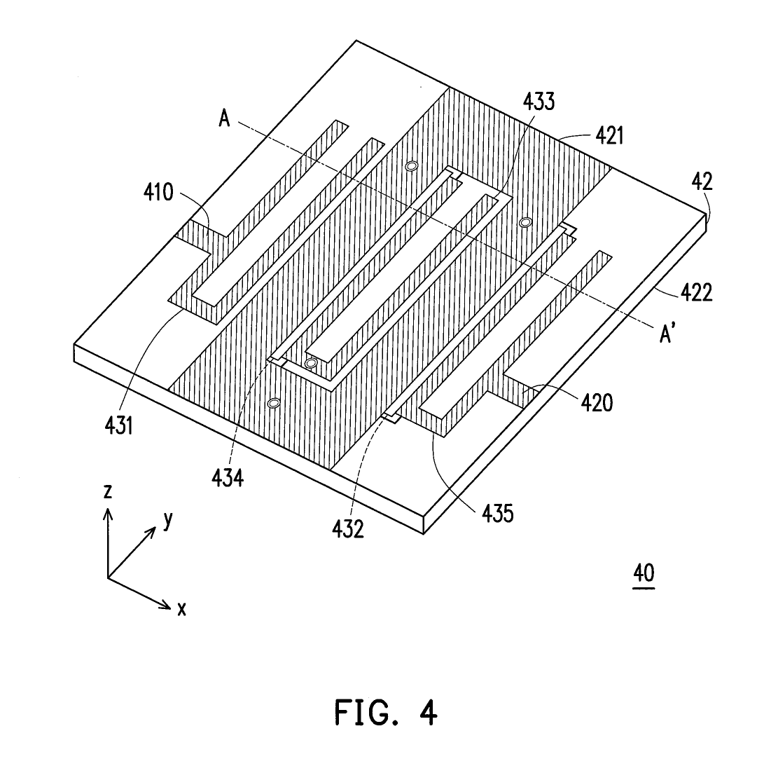

FIG. 4 is a schematic perspective view of a band-pass filter according to an embodiment of the invention. With reference to FIG. 4, a band-pass filter 40 includes a double-sided circuit board 42, an input terminal 410, an output terminal 420, and a plurality of resonance units 431-435. The double-sided circuit board 42 (also referred to as a double-sided board) has a first conductor layer 421 and a second conductor layer 422 disposed in an upper layer and a lower layer of the double-sided circuit board 42. In the present embodiment, the resonance units 431-435 are disposed in the first conductor layer 421 and the second conductor layer 422 respectively. It should be noted that, according to some embodiments of the invention, the number of the resonance units may be N, and N can be a positive integer greater than or equal to 3.

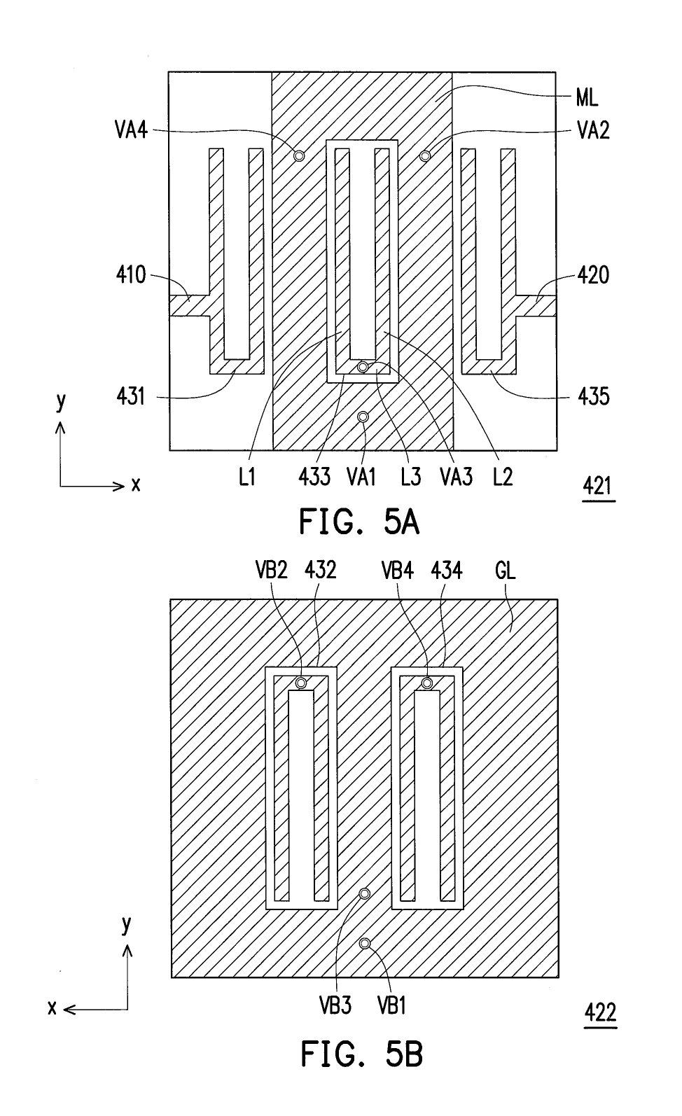

FIGS. 5A and 5B are used respectively in order to describe in detail the circuit design of the first conductor layer 421 and the second conductor layer 422. FIG. 5A is a schematic view of a first conductor layer 421 according to an embodiment of the invention. With reference to FIG. 5A, the first conductor layer 421 includes an input terminal 410, an output terminal 420, a plurality of resonance units 431, 433, and 435, and a grounded metal layer ML. Specifically, the input terminal 410 is directly connected to the resonance unit 431 to receive a signal, and the output terminal 420 is directly connected to the resonance unit 435 to output the filtered signal. The resonance units 431, 433, and 435 all have the same or similar structure, and therefore the resonance unit 433 is used as a representative to describe the structure thereof.

The resonance unit 433 includes a first conductive line L1, a second conductive line L2, and a connecting line L3. The first conductive line L1, the second conductive line L2, and the connecting line L3 are microstrip transmission lines, for example. The first conductive line L1 is parallel with the second conductive line L2. The connecting line L3 is connected to the first conductive line L1 and the second conductive line L2 perpendicularly, so as to form a hairpin circuit structure with an opening facing toward a positive y-axis direction. It should be noted that, the resonance unit 433 is different from the resonance units 431 and 435 in that, the resonance unit 433 has a via VA3 on the connecting line L3. The via VA3 may be disposed in any location on the connecting line L3. In the present embodiment, the via VA3 is disposed in a center location of the connecting line L3.

The first conductive line 421 has a grounded metal layer ML having at least one via VA1 to connect to the second conductor layer 422, although embodiments of the invention do not limit the position of the via VA1. In the present embodiment, the grounded metal layer ML further includes the vias VA2 and VA4. It should be noted that, embodiments of the invention do not limit the number of vias of the grounded metal layer ML, which may be set by people skilled in the art according to an applied situation in practice. The vias are holes filled or coated with metal, and the vias can connect the conductive lines on two sides of the double-sided circuit board. In other words, the vias are the bridges between the circuits so that the conductive lines can be interlaced on two different sides of the double-sided circuit board, suitable for use on complex circuit wiring designs.

FIG. 5B is a schematic view of a second conductor layer 422 according to an embodiment of the invention. Please refer to FIGS. 5B and 5A for the following description. The second conductor layer 422 includes the resonance units 432 and 434 and a grounded layer GL.

Specifically, the resonance units 432 and 434 and the resonance unit 433 have the same or similar structure, and therefore description thereof is omitted. A difference lies in that, the resonance units 432 and 434 has a hairpin circuit design with the openings facing a negative y-axis direction. Moreover, each of the resonance units in the second conductor layer 422 has vias to connect to the grounded metal layer ML in the first conductor layer 421. For example, the resonance unit 432 in the present embodiment has a via VB2 in a center location of the connecting line thereof. The via VB2 can connect to the grounded metal layer ML by connecting to the via VA2 in the first conductor layer 421. The resonance unit 434 has a via VB4 in a center location of the connecting line thereof. The via VB4 can connect to the grounded metal layer ML by connecting to the via VA4 in the first conductor layer 421.

The grounded layer GL in the present embodiment further includes the vias VA1 and VA3. The via VB1 is connected to the via VA1 of the first conductor layer 421, so that the grounded layer GL can be connected to the grounded metal layer ML. The via VB3 is connected to the via VA3 of the resonance unit 433, so that the resonance unit 433 can be connected to the grounded layer GL.

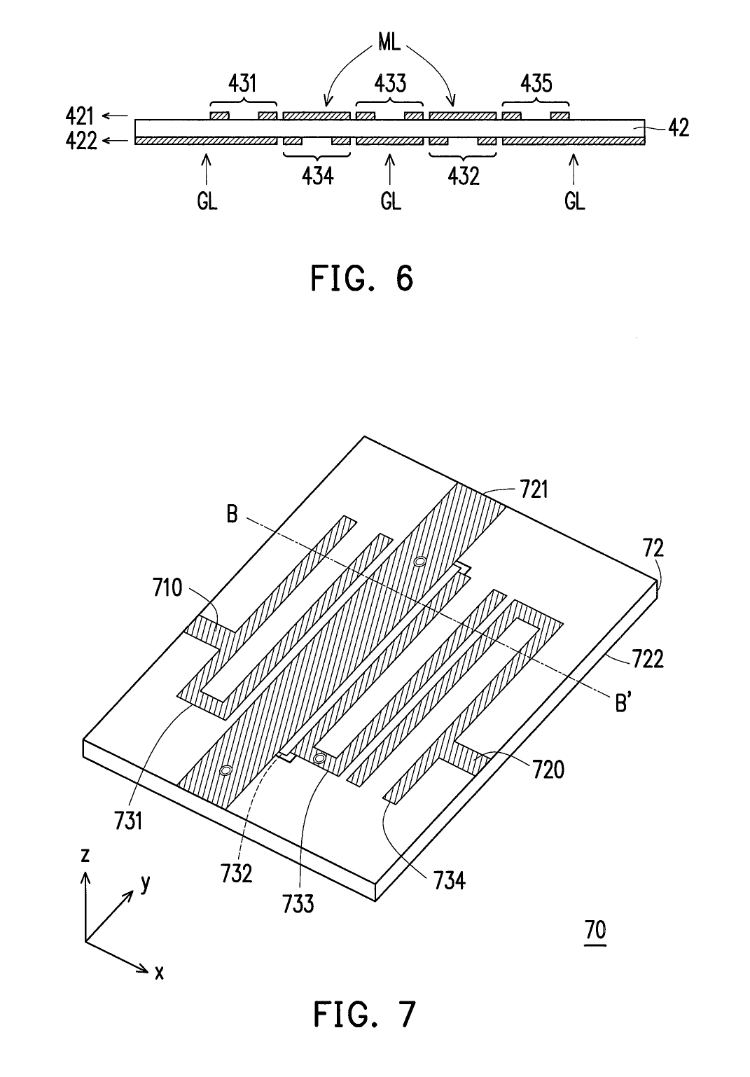

In order to further elaborate on the corresponding relationships of a circuit layout for the first conductor layer 421 and the second conductor layer 422, FIG. 6 is a schematic cross-sectional view along a A-A′ line shown in FIG. 4. With reference to FIGS. 4-6, the upper layer of the double-sided circuit board 42 is the first conductor layer 421, and the lower layer of the double-sided circuit board 42 is the second conductor layer 422. As shown in FIG. 6, the resonance units 431-435 are disposed interlaced in the first conductor layer 421 and the second conductor layer 422. Moreover, the first conductor layer 421 has the grounded metal layer ML, and the second conductor layer 422 has the grounded layer GL.

The band-pass filter 40 depicted in FIGS. 4-6 has an odd number of resonance units. Embodiments are described hereafter in which a band-pass filter has an even number of resonance units as examples showing that the invention can be realized.

FIG. 7 is a schematic perspective view of a band-pass filter according to another embodiment of the invention. With reference to FIG. 7, a band-pass filter 70 includes a double-sided circuit board 72, an input terminal 710, an output terminal 720, and a plurality of resonance units 731-734. The double-sided circuit board 72 has a first conductor layer 721 and a second conductor layer 722 disposed in an upper layer and a lower layer of the double-sided circuit board 72 respectively. In the present embodiment, the resonance units 731-734 are disposed in the first conductor layer 421 and the second conductor layer 422 respectively.

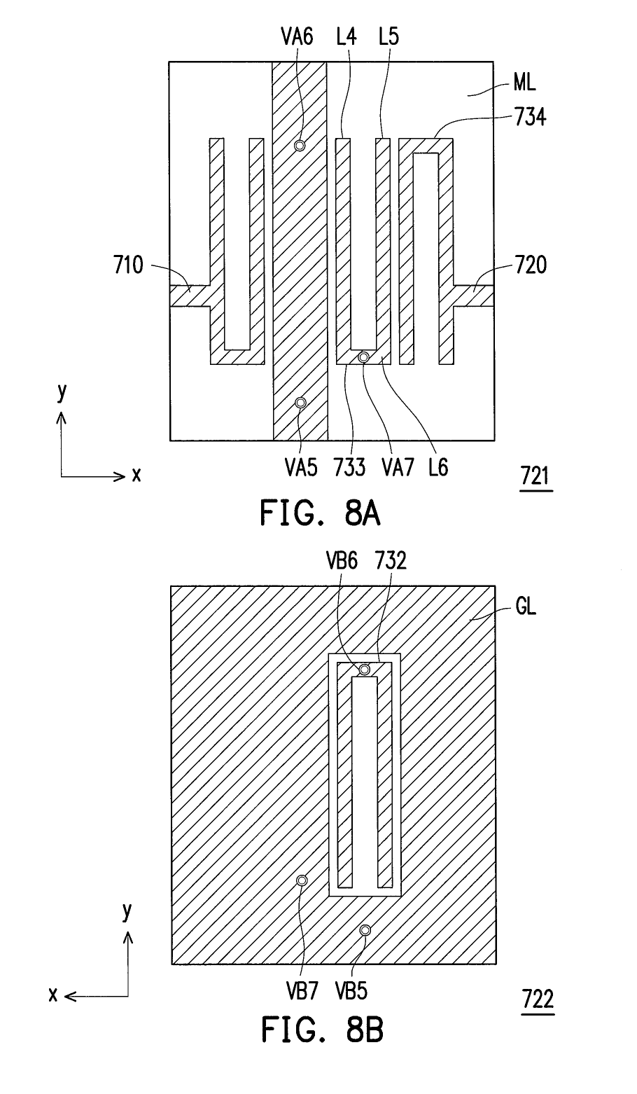

FIG. 8A is a schematic view of a first conductor layer 721 according to another embodiment of the invention. With reference to FIG. 8A, the first conductor layer 721 includes an input terminal 710, an output terminal 720, a plurality of resonance units 731, 733, and 734, and a grounded metal layer ML. Specifically, the input terminal 710 is directly connected to the resonance unit 731 to receive a signal, and the output terminal 720 is directly connected to the resonance unit 734 to output the filtered signal. The resonance units 731, 733, and 734 all have the same or similar structure, and therefore the resonance unit 733 is used as a representative to describe the structure thereof.

The resonance unit 733 includes a first conductive line L4, a second conductive line L5, and a connecting line L6. The first conductive line L4, the second conductive line L5, and the connecting line L6 are microstrip transmission lines, for example. The first conductive line L4 is parallel with the second conductive line L5. The connecting line L3 is connected to the first conductive line L4 and the second conductive line L5 perpendicularly, so as to form a hairpin circuit structure with an opening facing toward a positive y-axis direction. In the present embodiment, the resonance unit 733 is different from the resonance units 731 and 734 in that, the resonance unit 733 has a via VA7 on the connecting line L6. The via VA7 may be disposed in any location on the connecting line L3. In the present embodiment, the via VA3 is disposed in a center location of the connecting line L6, for example. On the other hand, the resonance units 731 and 734 respectively connected to the input terminal 710 and the output terminal 720 do not have vias. In the present embodiment, an opening direction of the resonance unit 731 is the same as an opening direction of the resonance unit 733, and an opening direction of the resonance unit 734 is the opposite to the opening direction of the resonance unit 733.

The first conductive line 721 includes a grounded metal layer ML having at least one via VA5 to connect to the second conductor layer 722, although embodiments of the invention do not limit the position of the via VA5. In the present embodiment, the grounded metal layer ML further includes a via VA6.

FIG. 8B is a schematic view of a second conductor layer 722 according to another embodiment of the invention. Please refer to FIGS. 8B and 7A for the following description. The second conductor layer 722 includes a resonance unit 732 and a grounded layer GL.

Specifically, the resonance units 732 and 733 have the same or similar structure, and therefore description thereof is omitted. A difference lies in that the resonance unit 732 has a hairpin circuit design with an opening facing a negative y-axis direction. Moreover, the resonance unit 732 has a via VB6 in a center location of the connecting line thereof. The via VB6 can connect to the grounded metal layer ML by connecting to the via VA6 in the first conductor layer 721. The grounded layer GL in the present embodiment further includes the vias VB5 and VB7. The via VB5 is connected to the via VA5 of the first conductor layer 721, so that the grounded layer GL can be connected to the grounded metal layer ML. The via VB7 is connected to the via VA7 of the resonance unit 733, so that the resonance unit 733 can be connected to the grounded layer GL.

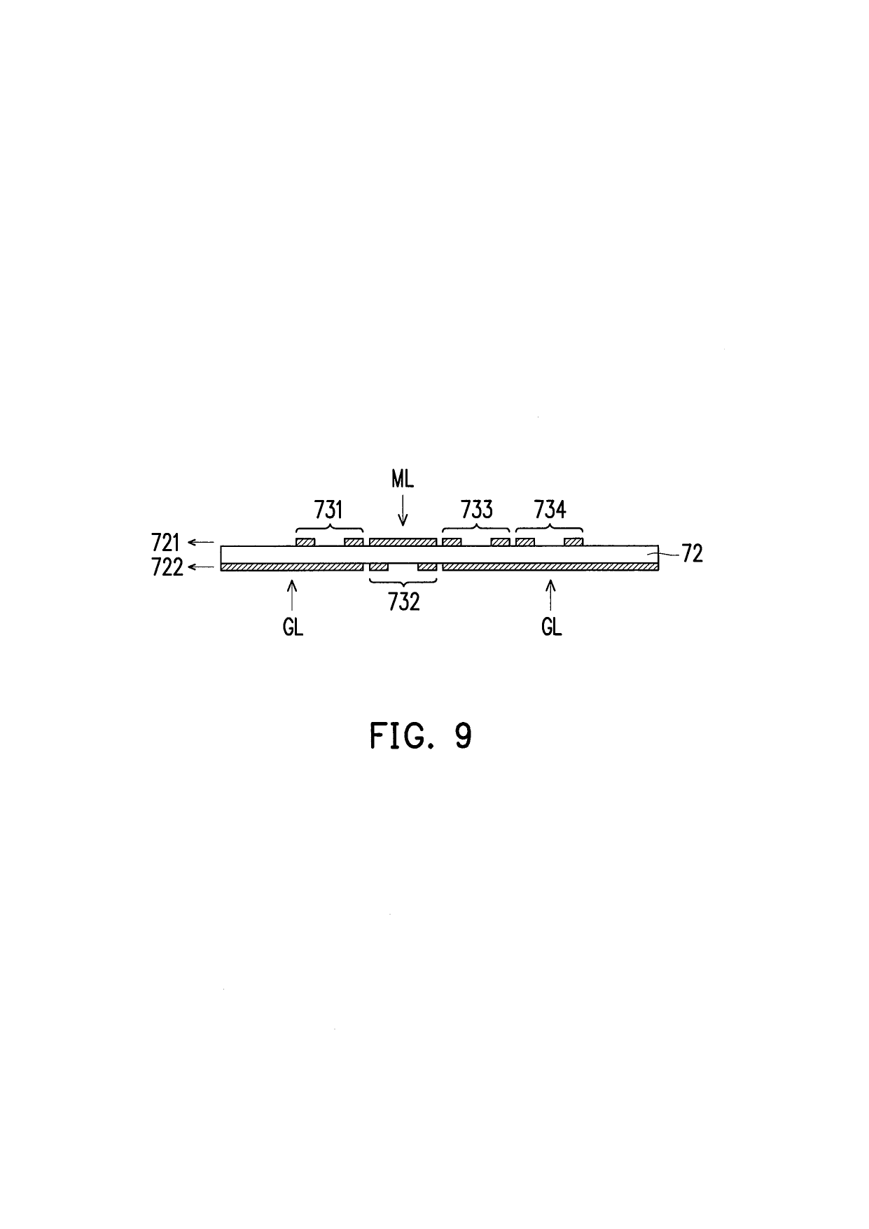

In order to further elaborate on the corresponding relationships of a circuit layout for the first conductor layer 721 and the second conductor layer 722, FIG. 9 is a schematic cross-sectional view along a B-B′ line shown in FIG. 7. With reference to FIGS. 7-9, the upper layer of the double-sided circuit board 72 is the first conductor layer 721, and the lower layer of the double-sided circuit board 72 is the second conductor layer 722. As shown in FIG. 9, the resonance units 732-733 not directly connected to the input terminal 710 and the output terminal 720 are disposed interlaced in the first conductor layer 721 and the second conductor layer 722. Moreover, the first conductor layer 721 has the grounded metal layer ML, and the second conductor layer 722 has the grounded layer GL.

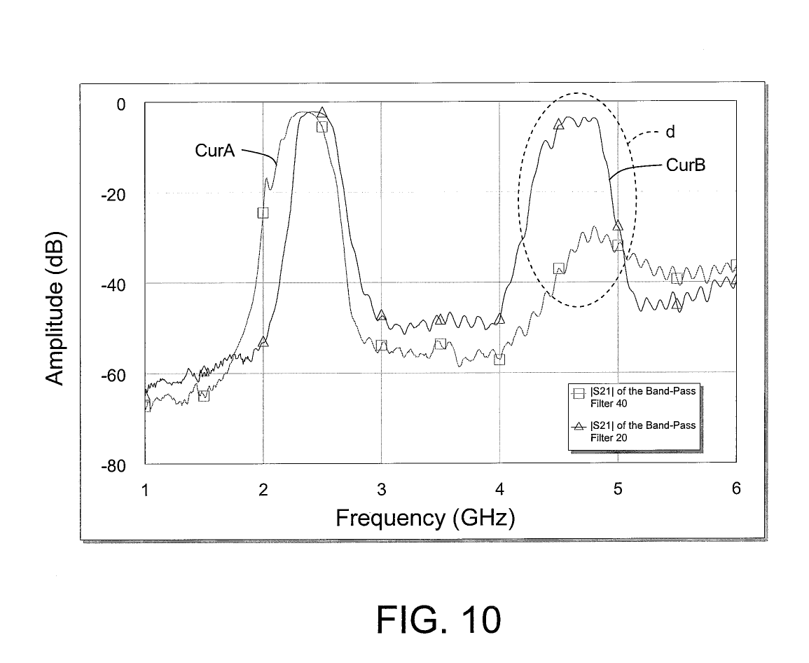

FIG. 10 is a comparative frequency response diagram of the band-pass filter 20 of FIG. 2 and the band-pass filter 40 of FIG. 4 obtained from an electromagnetic simulation. With reference to FIG. 10, the horizontal axis in the diagram represents the frequencies (unit: GHz) of the signals passing through the band-pass filters 20 and 40 according to the present embodiment, and the vertical axis represents the amplitude (unit: dB). A curve CurA depicts an amplitude (|S₂₁|) of a forward transmission coefficient of the band-pass filter 40 of FIG. 4. A curve CurB depicts an amplitude (|S₂₁|) of a forward transmission coefficient of the band-pass filter 20 of FIG. 2.

As shown in FIG. 10, the band-pass filter 40 has a preferable band-pass filter performance. Moreover, as shown in an area encircled by a dotted line d, |S₂₁| of the band-pass filter 20 is severely impacted by the interference from the second harmonic. By contrast, the noise of |S₂₁| of the band-pass filter 40 has been drastically reduced at the second harmonic area. By adopting a design of the band-pass filter 40 with the double-sided circuit board and the vias according to an embodiment of the invention, the interference issue of the band-pass filter generating the high frequency harmonic noise can be effectively mitigated.

In view of the foregoing, in the band-pass filter according to embodiments of the invention, for the resonance units between the input and output terminals, coupling structures are formed between different conductor layers of the double-sided circuit board, but adjacent circuits of the resonance units can all be connected to the grounded layer, so that the band-pass filter maintains the microstrip structure. Accordingly, compared to the parallel coupled microstrip band-pass filter, the band-pass filter invention can not only effectively reduce the area of the circuit board, but also achieve a preferable band-pass filtering function. Moreover, the band-pass filter in the invention can effectively prevent the issue of high frequency harmonic noise, and a low-pass filter connected in series is no longer required, thereby saving design and manufacturing costs.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A band-pass filter, comprising:
a double-sided circuit board having a first conductor layer and a second conductor layer, wherein the first conductor layer comprises a grounded metal layer having at least one via to connect to a grounded layer of the second conductor layer;
an input terminal disposed in the first conductor layer to receive a signal;
an output terminal disposed in the first conductor layer to output the filtered signal; and
a plurality of resonance units disposed in the first and second conductor layers respectively, the number of the resonance units being N, wherein N is a positive integer greater than or equal to 3.

2. The band-pass filter of claim 1, wherein a first resonance unit of the plurality of resonance units is directly connected to the input terminal, a second resonance unit of the plurality of resonance units is directly connected to the output terminal, and the first resonance unit and the second resonance unit are disposed in the first conductor layer.

3. The band-pass filter of claim 1, wherein each of the resonance units not directly connected to the input terminal or the output terminal are disposed interlaced in the first conductor layer and the second conductor layer.

4. The band-pass filter of claim 1, wherein each of the resonance units comprises a first conductive line, a second conductive line, and a connecting line, wherein the first conductive line is parallel with the second conductive line, and the connecting line is connected to the first conductive line and the second conductive line perpendicularly.

5. The band-pass filter of claim 4, wherein each of the resonance units disposed in the first conductor layer and not directly connected to the input terminal or the output terminal further comprises:
a via disposed in the connecting line to connect to the grounded layer of the second conductor layer.

6. The band-pass filter of claim 5, wherein the via disposed in each of the resonance units of the first conductor layer is further disposed in a center location of the connecting line.

7. The band-pass filter of claim 4, wherein each of the resonance units disposed in the second conductor layer further comprises:
a via disposed in the connecting line to connect to the grounded metal layer of the first conductor layer.

8. The band-pass filter of claim 7, wherein the via disposed in each of the resonance units of the second conductor layer is further disposed in a center location of the connecting line.
